(19) United States
(12) Patent Application Publication
(10) Pub. No.: US 2009/0150475 A1
(43) Pub. Date: Jun. 11, 2009

(54) Process Control System and Method

(75) Inventors: Martin John Peter Cebis, Wembley Downs (AU); Kirk Edward Turner, East Victoria Park (AU)

Correspondence Address: EDELL, SHAPIRO & FINNAN, LLC, 1901 RESEARCH BOULEVARD, SUITE 400, ROCKVILLE, MD, 20850, US

(73) Assignee: Embedded Technologies Corporation Pty Ltd., Willetton (AU)

(21) Appl. No.: 12/248,916

(22) Filed: Oct. 10, 2008

Related U.S. Application Data
(63) Continuation of application No. PCT/AU2007/000461, filed on Apr. 5, 2007.

(30) Foreign Application Priority Data
Apr. 10, 2006 (AU) 2006901850

(51) Int. Cl. G06F 15/16

(52) U.S. Cl. 709/202

(57) ABSTRACT

A process control system includes a network with sub-networks and one or more network servers coupled to these sub-networks via a router. Network users can access this network via network user terminals. The sub-networks include automation servers with peripheral devices coupled thereto. The automation servers control and configure the peripheral devices and can be accessed by local users using local user terminals. The network user terminals can query automation servers for data about the peripheral devices over the network. The automation devices can be selected and identified by data relating to their geographical location.

### FIELD OF THE INVENTION

The present invention relates to a process control system and method for managing an automation system, particularly, although not exclusively for managing an automation system for use in security and situational awareness applications. Such a system provides for the logging of data, monitoring of the current state and automatic control actions at a local level and at a wider level.

Throughout the specification, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification, unless the context requires otherwise, the word “include” or variations such as “includes” or “including”, will be understood to imply the inclusion of a stated integer or group of integers but not the exclusion of any other integers or group of integers.

### BACKGROUND ART

The following discussion of the background of the invention is intended to facilitate an understanding of the invention. However, it should be appreciated that the discussion is not an acknowledgement or admission that any of the material referred to was published, known or part of the common general knowledge of the person skilled in the art in any jurisdiction as at the priority date of the application.

Presently, process control automation systems are most often designed as a complete system with a system-wide self contained control problem to be solved by the system. In known systems, the complete system design is well characterised and downloaded to a control device such as a Programmable Logic Controller (“PLC”). Such a control solution is not easy for employees in an enterprise to use. It must be relevant to their work environment. Typical systems are often installed, maintained and adapted by specialist engineers and used by technicians. Furthermore, such systems are usually implemented as large centrally managed networks which are large and unwieldy to manage. A decentralised approach is to network together multiple systems to form a ‘network of networks’ so that the system is more modular. The present invention describes a modular approach to the problem that is meaningful for the different people and groups accessing the system.

In security and in other automation applications, systems are often implemented with information in “stovepipes” where there are separate systems for Closed Circuit Television (“CCTV”), security, position, controls, building management and others. This leads to costly and complex engineering in order to unify disparate systems. The present invention overcomes this with an architecture that unifies many different sources of information and control and yet is simple to be managed even by staff who are not engineers.

International Patent Application No. PCT/AU2004/000243 describes a process control system and a method for configuring such a system. The system comprises a programmable automation controller that has one or more process control peripheral devices coupled thereto. The programmable automation controller can be configured to define information about the peripheral devices including trigger conditions and alarm conditions. Information about the peripheral devices can be accessed by users through a user terminal coupled to the programmable automation controller. The peripheral devices operate in accordance with the configuration information and can transfer data to the programmable automation controller.

International Patent Application No. PCT/AU2005/001314 describes a process control system and a method in which peripheral devices are controlled by a controller. The peripheral devices are located in environments that are arranged in a hierarchical nature. Each peripheral device has a unique hierarchical identifier depending upon the environment in which it is located. If the environment changes then so does the unique identifier. This unique identifier can be used for control of the peripheral device in accordance with its identifier.

### DISCLOSURE OF THE INVENTION

In accordance with a first aspect of the present invention, there is provided a process control system comprising a network of sub-networks, each sub-network comprising an automation server having at least one peripheral device coupled thereto, and having data stored thereon, including location data for the automation server and additional data, the network further including at least one network server with a network user terminal coupled thereto, and whereby each of the automation servers within the network is coupled to one of the at least one network servers for communication of data therebetween, the at least one network server being operable to receive data exported from a selected automation server transmitted in response to a query from one of the at least one network servers to the selected automation server, whereby the selected automation server is queried by the network server on the basis of the location data.

Preferably, the one of the at least one network servers is operable to query a selected automation server on the basis of a match of its location to a selected geographical location. Alternatively, the one of the at least one network servers is operable to query a selected automation server on the basis of its near location to a selected geographical location.

Preferably, the one of the at least one network servers is operable to transmit the query as a broadcast query to all automation servers. Alternatively, the one of the at least one network servers is operable to transmit the query as a broadcast query to selected automation servers, or the one of the at least one network servers is operable to transmit the query by sequentially polling all automation servers.

Preferably, the data received by the one of the at least one network servers is stored locally at the one of the at least one network server for subsequent access. Preferably, the one of the at least one network servers is operable to emit an alert in response to the receipt of data from the selected automation server.

Preferably, the process control system further includes a configuration server provided in the network and coupled to the sub-networks and the at least one network server, for storage of data exported from automation servers of the sub-networks thereon, such that one of the at least one network servers is operable to retrieve data from the configuration server.

Preferably, the process control system further includes a processing server provided in the network and coupled to the sub-networks and the at least one network server, the processing server being operable to query selected automation servers of the sub-networks for further processed data.

Preferably, the automation server and the network server are a single server.

Preferably, the network server is operable as an automation server and includes one or more peripheral devices coupled thereto

In accordance with a second aspect of the present invention, there is provided a method of process control using a process control system comprising a network of sub-networks, each sub-network comprising an automation server having at least one peripheral device coupled thereto, and having data stored thereon, including location data for the automation server and additional data, the network further including at least one network server with a network user terminal coupled thereto, and whereby each of the automation servers within the network is coupled to one of the at least one network servers for communication of data therebetween, the method including the steps of: querying one or more of the automation servers on the basis of the location data by transmission of a query from one of the at least one network servers; and receiving data exported from an automation server transmitted in response to the query from one of the at least one network servers to the automation server.

Preferably, the query is on the basis of a match of the location of the automation server to a selected geographical location. Alternatively, the query is on the basis of the near location of an automation server to a selected geographical location.

Preferably, the query is broadcast to all automation servers. Alternatively, the query is broadcast to selected automation servers, or the query is a sequential polling of all automation servers.

Preferably, the method includes the step of storing the data received by the one of the at least one network servers locally at the one of the at least one network server for subsequent access.

Preferably, the method further includes the steps of storing data exported from automation servers of the sub-networks on a configuration server provided on the network, and retrieving data from the configuration server.

Preferably, the method includes the step of querying selected automation servers of the sub-networks for further processed data.

In accordance with a third aspect of the present invention, there is provided a network server for a process control system, the network server being provided in a network of sub-networks, each sub-network comprising an automation server having at least one peripheral device coupled thereto, and having data stored thereon, including location data for the automation server and additional data, the network further including at least one network server with a network user terminal coupled thereto, and whereby each of the automation servers within the network is coupled to one of the at least one network servers for communication of data therebetween, the at least one network server being operable to receive data exported from a selected automation server transmitted in response to a query from one of the at least one network servers to the selected automation server, whereby the selected automation server is queried by the network server on the basis of the location data.

Preferably, the one of the at least one network servers is operable to query a selected automation server on the basis of a match of its location to a selected geographical location. Alternatively, the one of the at least one network servers is operable to query a selected automation server on the basis of its near location to a selected geographical location.

Preferably, the one of the at least one network server is operable to transmit the query as a broadcast query to all automation servers. Alternatively, the one of the at least one network server is operable to transmit the query as a broadcast query to selected automation servers, or the one of the at least one network server is operable to transmit the query by sequentially polling all automation servers.

Preferably, the one of the at least one network server is operable to emit an alert in response to the receipt of data from the selected automation server.

In accordance with a fourth aspect of the present invention, there is provided a configuration server for a process control system, the configuration server being provided in a network of sub-networks, each sub-network comprising an automation server having at least one peripheral device coupled thereto, and having data stored thereon, including location data for the automation server and additional data, the network further including at least one network server with a network user terminal coupled thereto, and whereby each of the automation servers within the network is coupled to one of the at least one network servers for communication of data therebetween, wherein the configuration server is coupled to the sub-networks and the at least one network server, for storage of data exported from automation servers of the sub-networks thereon, such that one of the at least one network servers is operable to retrieve data from the configuration server.

In accordance with a fifth aspect of the present invention, there is provided a processing server for a process control system, the processing server being provided in a network of sub-networks, each sub-network comprising an automation server having at least one peripheral device coupled thereto, and having data stored thereon, including location data for the automation server and additional data, the network further including at least one network server with a network user terminal coupled thereto, and whereby each of the automation servers within the network is coupled to one of the at least one network servers for communication of data therebetween, wherein the processing server is operable to query selected automation servers of the sub-networks for further processed data.

The flexibility of the present invention, particularly when applied to a security automation model, delivers operational flexibility by allowing both decentralized and centralized management and operation. By removing the need for cumbersome re-engineering, there is provided a flexibility to adapt systems that is devolved to those with domain expertise. This enables systems to be easily adjusted for different threat levels and pre-emptive covert operations where discriminatory information capture requires adjustment.

### BRIEF DESCRIPTION OF THE DRAWINGS

The present invention will now be described, by way of example only, with reference to the accompanying drawings, of which:

FIG. 1 is a schematic illustration of a first embodiment of a process control system in accordance with an aspect of the present invention;

FIG. 2 is a schematic illustration of a second embodiment of a process control system in accordance with an aspect of the present invention;

FIG. 3 is a schematic illustration of a third embodiment of a process control system in accordance with an aspect of the present invention;

FIG. 4 is a schematic illustration of a fourth embodiment of a process control system in accordance with an aspect of the present invention;

FIG. 5 is a schematic illustration of a fifth embodiment of a process control system in accordance with an aspect of the present invention;

FIG. 6 schematically illustrates a simple querying process between network and automation servers;

FIG. 7 schematically illustrates a publish/subscribe querying process between network and automation servers;

FIG. 8 illustrates a querying process used by the embodiment of FIG. 2;

FIG. 9 is a schematic illustration of a sixth embodiment of a process control system in accordance with an aspect of the present invention;

FIG. 10 is a schematic illustration of a process control system used in a security and situational environment operating as a security automation system; and

FIG. 11 is a schematic layer model of the security automation system of FIG. 10.

### BEST MODE(S) FOR CARRYING OUT THE INVENTION

A process control system 500 of an embodiment of the present invention comprises a network 100 that can be accessed by one or more users.

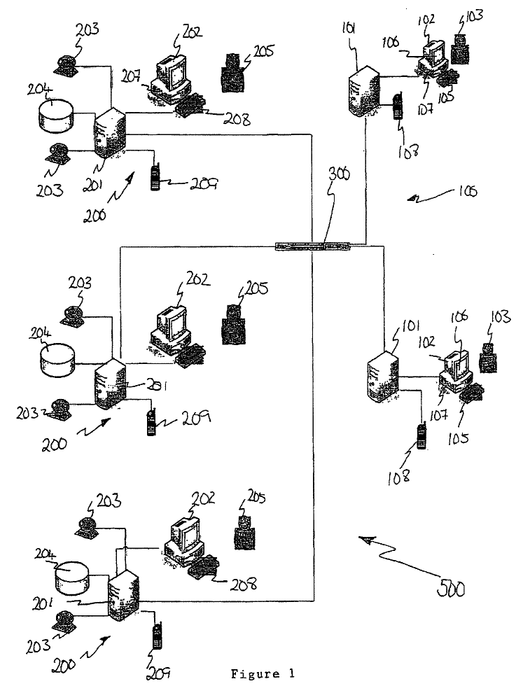

The network 100 includes one or more network servers 101 and one or more sub-networks 200. In the embodiment illustrated in FIG. 1, the network 100 comprises three sub-networks 200; each coupled via a router 300 to two network server 101 and to the other sub-networks 200. However, it should be understood that the number of sub-networks 200 can vary as can the number of network servers 101.

Each network server 101 is coupled to a network user terminal 102, such as a personal computer or other suitable user interface, which is accessible by a network user 103, and used to access, control and configure the network 100 as will be described in further detail below. The network user terminal 102 may include a keyboard 105, and a visual display 106, with, for example, a touch screen. The network user terminal 102 also includes a suitable processor 107 to facilitate data communication with the network server 101. The use and operation of such network user terminals 102 is well known to persons skilled in the art and need not be described in any further detail herein, except as is relevant to the present invention.

Each network server 101 is also coupled to a network server database 104.

Each network server 101 may also be coupled to an optional alerting device 108, such as a cellular hand-held radio telephone or other suitable device, for providing alerts to a user.

Each sub-network 200 comprises an automation server 201 coupled to one or more peripheral devices 203, and to a local user terminal 202 such as a personal computer or other suitable user interface, for use by a local user 205 to access, control and configure the sub-network 200 and the peripheral devices 203 provided therein. The local user terminal 202 may include a keyboard 208, and a visual display 206, with, for example, a touch screen. The local user terminal 202 also includes a suitable processor 207 to facilitate data communication with the automation server 201. The use and operation of such local user terminals 202 is well known to persons skilled in the art and need not be described in any further detail herein. The peripheral devices 203 can be analogue or digital devices and can include, but are not limited to, cameras, sensors, actuators, and security devices.

The automation server 201 comprises memory, processing means, storage means and I/O ports, as is well known to persons skilled in the art.

Storage means includes a database 204. The database 204 can take a variety of forms including a fixed or removable hard disc or solid state memory means. Similarly, I/O ports may take a variety of forms including cable, wireless, infrared and PCI/ISA card. The database 204 stores data and information for use by the automation server 201 and includes configuration and other data relating to the automation server 201 and peripheral devices 203 coupled thereto and which can be exported to other automation servers 201, network servers 101 and other servers provided within the network 100 and which will be described in further detail below.

The automation server 201 is in data communication with the peripheral devices 203 and the local user terminal 202 through the I/O ports, as well the network servers 101 on the network 100, via the router 300. The local user terminal 203 is in control communication with the automation server 201. The automation server 201 is in control communication with the peripheral devices 203. In this embodiment, data and control communication is achieved through non-proprietary communication standards, such as TCP/IP and Bluetooth.

Each automation server 201 is coupled to an optional alerting device 209, such as a cellular hand-held radio telephone or other suitable device, that can deliver alerts to a user.

The local user terminal 202, in the embodiment described herein, is a computer typically of standard configuration as would be evident to the person skilled in the art.

A local user 205, who may or may not be a process engineer or other similarly skilled person, installs peripheral devices 203 at desired locations. The local user 205 then installs the automation server 201 at an additional desired location and takes such action as necessary to secure data and control communication between the automation server 201 and the peripheral devices 203.

The local user 205 is then able to configure the automation server 201 and the peripheral devices 203. Configuration commences with the local user 205 executing software recorded on the automation server 201 by appropriate inputs via the local user terminal 202.

Configuration includes, but is not necessarily limited to:
defining the environment in which the peripheral device 203 is located;
detecting and storing details of the peripheral device 203 in the manner of “plug and play” known to persons skilled in the art;
defining communication channels between the peripheral device 203 and the automation server 201;
setting operating parameters for the peripheral device 203 as required;
defining any trigger conditions for the peripheral device 203;
defining any alerts and alarms relevant to the peripheral device 203;
defining and setting control actions and/or sequences for the peripheral devices 203, as required;
defining and setting calibration information for the peripheral device 203;
providing geographical information relating to the location of the peripheral device 203; and
any other parameters or information relevant to the peripheral device.

In an alternative embodiment of the invention, other suitable configuration processes can be used as is known to persons skilled in the art, depending upon the nature of the automation server 201 and the peripheral devices 203 coupled thereto.

Data regarding the configuration is stored in the database 204 as mentioned above.

In one embodiment of the invention, the environments and the peripheral devices 203 provided therein are organised in hierarchies to assist a user to manage and configure the peripheral devices 203 as a process control system and to deliver flexible and useful control functions. The peripheral devices 203 may have their control actions dependent upon and ordered with other devices and trigger conditions. Control actions may also depend upon the environment in which the peripheral device 203 is located.

Each peripheral device 203 has a hierarchical identifier associated therewith which defines the peripheral device 203 in terms of its environment and sub-environments. This hierarchical identifier is generated and stored at the automation server 201, and allows control sequences to be set up involving one or more devices by defining the dependencies between devices and their trigger conditions. Changes in the environment (and therefore in its identifier) can trigger control actions and/or a sequence of actions to be initiated under control of the automation server 201. Along with control actions, information about the type of device and operational parameters and characteristics that it has can be linked to the hierarchical information and is stored in the automation server 201, as part of the configuration process. As mentioned above, configuration data for a peripheral device 203 can include the location of the environment or device, a pictorial representation, calibration parameters, control sequences, trigger levels and dependencies on other devices. Examples of this include a picture of the device or the operational and calibration parameters that it uses to be read (if a sensor) or activated (if an actuator).

Each peripheral device 203 can be a physical device such as a sensor, switch or valve, or can be a virtual device modelled by part of a computing method and implemented in the automation server 201. Such virtual devices offer greatly increased flexibility. For example, they can represent switches activated by a graphical picture on a touch screen or they can offer delay or timing functions. They can indicate a dependency on a logical set of conditions (either defined by device trigger conditions and dependencies on other peripheral devices 203, or by computer program logical statements) before operation or assessment of the device is initiated. They can also temporarily replace real devices for testing purposes. Such virtual devices can also be organised into a system of hierarchies and environments as with real devices.

The peripheral devices 203 could also be people, animals or any other object - and the term should be construed accordingly. Devices may also be considered to be environments for other devices.

As mentioned above, the peripheral devices 203 are associated with hierarchically organised environments. Each environment may have stored with it the graphical or pictorial representations of the environment and the spatial separation, topological organisation and geographical location relative to the other environments in the hierarchy. While this information could be relative to the other environments and peripheral devices 203, it could also be absolute by using geographical coordinates.

Alternatively, the previous hierarchically organised peripheral devices 203 and their control information can be defined by another more conventional means such as by the interrogation of a separate database containing substantially the same information.

Further, the relationships between the hierarchies of peripheral devices 203 can be changed manually or dynamically and this in itself can trigger automation actions or new automation sequences.

The automation server 201 can also contain a “logged” history of the past state of the peripheral devices 203 and can also allow monitoring of the present state of the process control system 500. This data would be stored in the database 204.

Each automation server 201 may be locally or remotely managed over its relevant sub-network 200.

Management of a sub-network 200 is managed by the relevant automation server 201. Local users 205 of a sub-network 201 can access the automation server 201 directly to manage and modify the sub-network 201 and the peripheral devices 203 provided therein. It will be understood that local users 205 may be located remotely of the sub-network 200 and may still access the automation server 201 and for the purposes of this document are referred to as local users. The automation server 201 handles logging, automation, monitoring, alerts and alarms at its level as set by the local user 205. In FIG. 1, three automation servers 201 are shown but there could be any arbitrary number (N) of them, as discussed above.

As mentioned above, geographical information can be provided as part of the configuration data. Geospatial information, such as geospatial coordinates, for each peripheral device 203 may be entered via the local user terminal 202 for each peripheral device 203 when it is added to the process control system 500 during the configuration process. In particular, geographical coordinates could be explicitly entered for each environment in which a peripheral device 203 is located, or each peripheral device 203 within the environment could inherit the geospatial reference of the environment in which it is located. If the absence of more accurate data, sub-environments could inherit the geospatial coordinates of their parent environment. Coordinates could be entered manually by typing in via the local user terminal 202, or be provided from another machine such as a Global Positioning System (“GPS”) device in a more automated and convenient fashion.

The geospatial coordinates could be explicitly entered as absolute globally referenced points such as latitude and longitude or another coordinate system. Alternatively the geospatial coordinates could be entered relative to a point of global reference in terms of distance or calculated from a fixed position either by manual measurement of estimation, or from a graphical picture of a facility of known scale with a point of global reference. For example, a convenient global reference point could be the location of the automation server 201 itself. It can be easily seen that this information is sufficient to calculate the absolute geospatial coordinates of each peripheral device 203 and the environment in which it is located even if the reference point or environment is moving, such as in the case of a person or in a vehicle, as well as providing convenient data entry for the person managing the automation system.

The geospatial coordinates and other metadata may be used, imported or exported between the automation servers 201 and the network servers 201 in accordance with the process described in International Patent Application No. PCT/AU2005/001314 or any other suitable or applicable method such as database access. As an example, data can be imported as a comma-separated variable data file, or using open standard formats such as CORBA and XML.

Furthermore, the geospatial coordinates and other metadata may be exported over the network 100 to the one or more of the network servers 101 via the router 300 as metadata with alerts or with the output data that is collected and stored on the automation server 201. In one embodiment, the metadata is automatically shared with all the network servers 101, while in some circumstances, the network servers 101 may be hierarchically grouped to better organise the process control system 500 to match geographical or organisational functional groups. In the embodiment described herein, the network servers 101 are geographical information system (GIS) servers that can display on a map or a grid, the numbers of network servers 101 that are in the network 100 either in a flat or a hierarchical style in any suitable manner.

GIS servers are well known in the art and need not be described in any further detail herein, except as is relevant to the present invention.

The network servers 101 query individual automation servers 201 for information on its configuration and the peripheral devices 203 coupled thereto, and the data can be exported to the network servers 101 in response to such a request. These queries are based upon specific requests from network users 103 using the network user terminals 102 to access a specific automation server 201 or to access an automation server 201 which is the nearest based upon the automation server 201 to a geographical point of interest. Once the automation server 201 has been queried, configuration data from the relevant queried automation server 201 may be stored locally at the network server 101 to speed up future queries. In this way, this network server 201 operates as “central configuration server”. A network user 103 is thus able to browse the process control system 500 geographically using the metadata exported by the automation servers 201 to the network servers 101 via the network 100. Optionally, a network server 101 may process data queried from an automation server 201 to issue its own levels of alerts, thus performing the function of an automation server 202. Alerts are communicated by any suitable analogue or digital communication means.

The presence of an alert or available data and metadata can be displayed to a user via the visual display 106 of the network user terminal 102 by a visual indication such as, for example, flashing of an icon on the visual display 106 or a change colour. This would could warn or invite a user 103 to investigate further by the use of the keyboard 105, and/or by clicking on the network server 101 location to browse and manage the resources available in that network server 101 or just to receive the specific alert or data that has been generated.

Data that is stored in the database 204 of each automation server 201 can be accessed by a network user 103 using a network server 101 using location of the relevant automation server 201 as the means to identify the correct automation server 201. The data could be determined to be relevant only if the geospatial coordinates exactly matched the geospatial coordinates of an automation server 201. Alternatively, a distance computation might be used to return the nearest located automation server 201 or automation servers 201 within a given radius from a given point of interest. Alternatively, the automation servers 201 within a bounded area described by a polygon or other geometrical shape might be returned. Alternatively, the automation servers 201 can be identified through the absolute location of peripheral devices 203 to which the automation server 201 is coupled. This can be achieved by sending a specific query to a chosen number of automation servers 201, by sending a broadcast query to all automation servers 201 coupled to the network 100, or by sequentially polling of all known automation servers 201 coupled to the network 100.

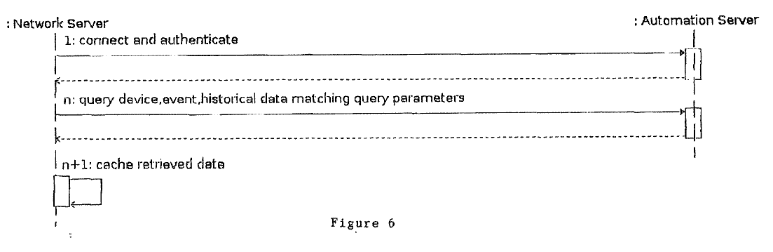

An embodiment of the querying process will now be described in further detail. A query to an automation server 201 initially requests data regarding the peripheral devices 203 and the environments that are located at the queried automation server's 201 location to provide a foundation to access the peripheral devices 203 and environments that are available in a hierarchical fashion or in an absolute geographical form. The query process is illustrated schematically in FIG. 6. The network server 101 connects to the automation server 201 and carries out an authentication process. Once connection has been established, then the network server 101 is operable to query the automation server 201 and retrieve device, event, or other data matching the query parameters. The network server 101 is then operable to cache the retrieved data. This data is then exported to the network server 101 used to perform the query. Any suitable querying process could be used. An example of the data requested by the query could be to request all information for all of the peripheral devices 203 located in a particular environment which could be, for example, a room or a vehicle. Other data requested, could, for example, be information relating to one specific peripheral device 203. The data could be requested completely hierarchically or on the basis of geographical coordinates, or by a combination of these methods. It is also possible that data might be requested from one or more automation servers 201 depending upon, for example, the type of peripheral device 203 such as digital sensors such as motion detectors, or analogue sensors such as temperature sensors, or peripheral devices providing audio and video data. It is also possible that queries based on metadata of many forms alone or in combination would be accommodated within the network server 101 as might be accommodated by a traditional database.

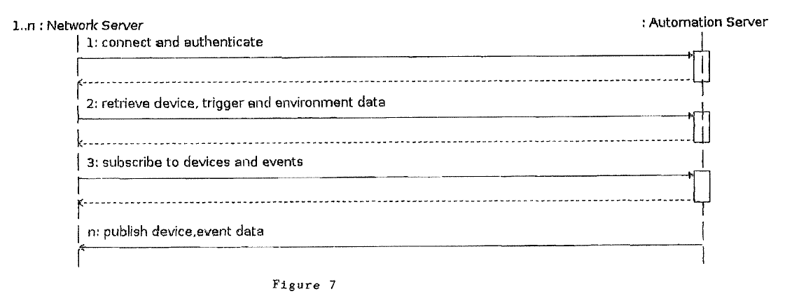

Alternatively, a publish/subscribe model can be implemented whereby the network server 101 can subscribe to any device change, and configuration change data, and control events relating to a peripheral device 203. When device, configuration changes and/or control events occur on the automation server 201, the information is published to all subscribed network servers 101. This process is illustrated schematically in FIG. 7.

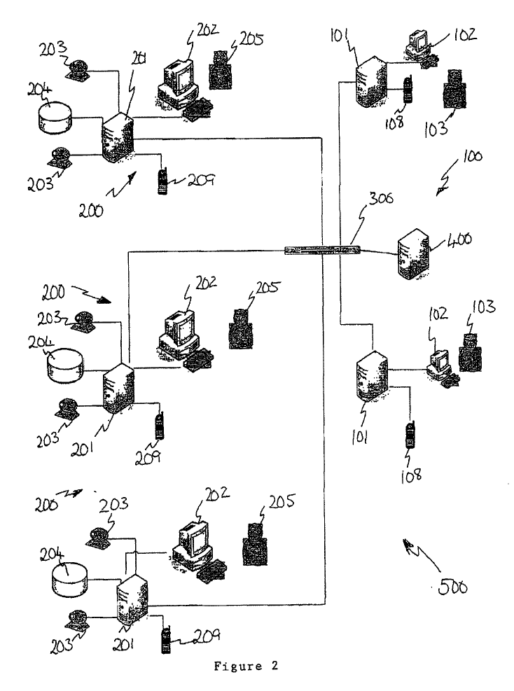

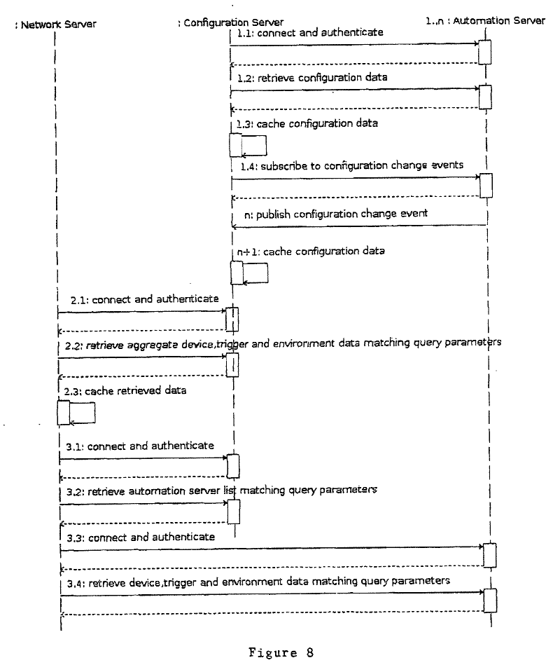

In an alternative embodiment, illustrated in FIG. 2, where like features are referenced by like numerals, the network 100 includes a central configuration server 400 of which there is typically one for each logical grouping of automation servers 201. The configuration server 400 is coupled to the sub-networks 200 and the network servers 101 via the router 300. Rather than querying each automation server 201 for its configuration and metadata, the configuration and appropriate metadata is stored in the central configuration server 400 in the fashion of a database. Any of the network servers 100 that require data regarding the automation servers 201 or the peripheral devices 203 coupled thereto can retrieve the required data directly from the configuration server 400 and automation servers 201 are operable to update the central configuration server 400 if changes to their configuration are made. This process is illustrated schematically in FIG. 8. The configuration server 400 connects with the automation server 201, and retrieves and stores data such as configuration data and configuration change events. The network server 101 is then operable to connect to and query the configuration server 400 and retrieve data matching the query parameters. This data is then cached by the network server 101. The network server 101 is then further operable to query the configuration server 400 for a list of those automation servers 201 which match the query parameters. On the basis of this list, the automation server 201 is then able to query the relevant automation servers 201 for the data that matches those query parameters. The automation servers 201 browse the network 100 as before and carry out optional processing and alerts as before. The advantage of this configuration is that both the automation servers 201 and network servers 101 have a single point of contact for configuration information.

Typically there would only be one central configuration server 400 although more may be used to provide redundancy. If the number of central configuration servers equals the number of network servers 101, the network servers 101 might perform the configuration server role and might also have a redundant configuration server role in case of failure of the central configuration server 400.

When a network server 101 has the initial required information relating to the peripheral devices 203 and the related environments further requests for data may be made by the network servers 101 on an individual basis for each environment, peripheral device 203 or group of peripheral devices 203 or environments. If this is to be relied upon then changes to the automation servers environments and peripheral devices 203 coupled thereto, say in the configuration, availability or location, must be updated at the network server 101. This can be done using any suitable, known method, for example by subscription by the network server 101 to updates from each automation server 201 itself or by subscription to an aforementioned central configuration server 400 that acts as a repository and a database of such changes that are notified to it by the automation servers 201.

By configuring the process control system 500 in this way, new capability is enabled because data from peripheral devices 203 and environments—data that can include analogue, digital, audio and video as well as metadata about the content, including very importantly, the time that it was captured, and where and why—may be accessed. This data may be further post processed by a network server 101 to look for patterns in the logged data or to enhance the processing of specific audio and video data for further alert and actions. If this were done on the automation server, this could only be achieved for data on that specific automation server 201. For example, a video picture might be analysed for motion or specific content using complex algorithms.

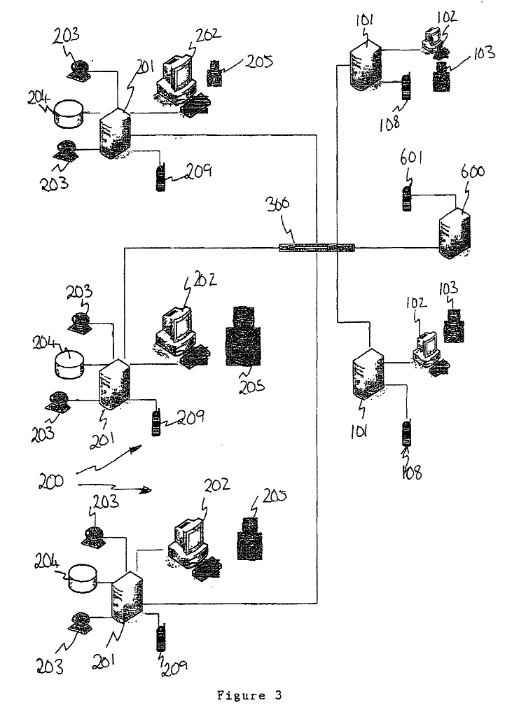

In a third embodiment of the invention illustrated in FIG. 3, the network 100 includes a processing server 600, coupled to the sub-network 200 and the network servers 101 via the router 300. In this embodiment, and where wider data is needed, the processing server 600 is operable to query the automation servers 201 as required for further processed data. In this way the data can first be filtered by the automation server 201 and then passed to the processing server 600 that is dedicated to the computationally intensive task of analysing video or large data sets for patterns. The processing server 600 is operable to issue its own alerts, and, in this regard is coupled to an alerting device 601 to which alerts can be sent. An example of an alerting device can be a handheld cellular radio telephone. Alternatively, the processing server 600 is operable to return results to the network servers 101 for further analysis and alert issue as required.

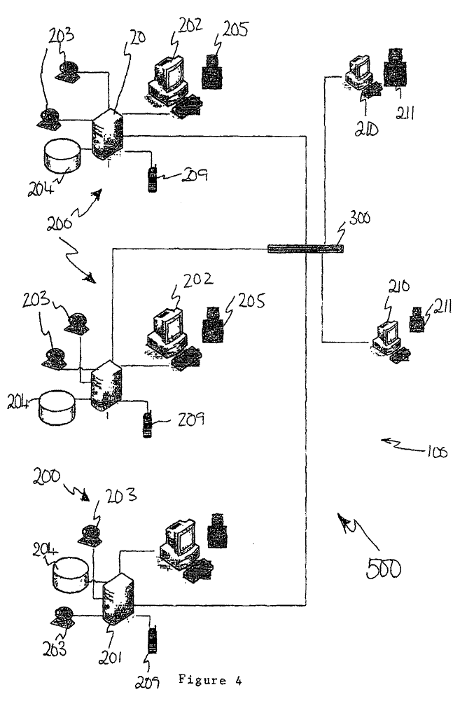

In a fourth embodiment of the invention illustrated schematically in FIG. 4, all browsing processing and alerts occur in the automation servers 201 and remote network users 211 browse each automation server 201 directly by its sub-network 200 location. In this regard, remote network users 211 use remote network terminals 210 that are arranged to be in data communication with the automation servers 201 via the router 203.

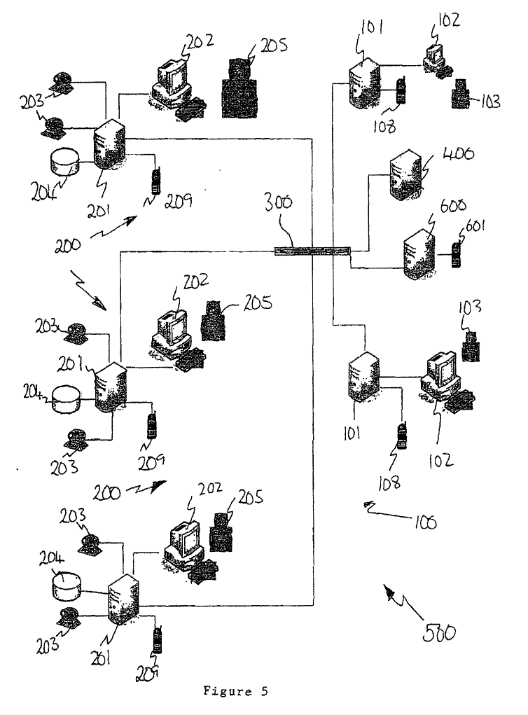

In a fifth embodiment of the invention illustrated schematically in FIG. 5, the second and third embodiments are combined. In this embodiment, therefore, processing and management of the configuration server 400 is separate from the network servers 101.

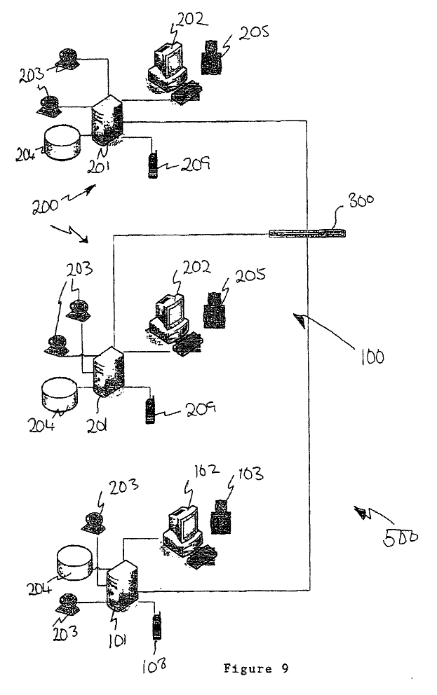

In a sixth embodiment of the invention illustrated schematically in FIG. 9, a network server 101 acts as an automation server attaching none or one or more automation servers 101 as peripheral devices in addition to one or more locally coupled peripheral devices 203. Additionally, the peripheral devices 203 coupled to the attached automation servers 201 are coupled with the network server 101 using the attached automation server 101 as a proxy. The coupled peripheral devices 203 are maintained within the environmental hierarchies of the remote automation servers 201. The subscribe/publish query method described above is utilised to provide the information and events to the network server 101. The network server 101 and automation server 201 relationship could be replicated N levels deep allowing for aggregation that replicates the heirarchical model at a server level.

In summary, the net result is that automation servers 201 can be more rugged and of lower specification and be focussed on data acquisition and control while more computationally intensive analysis and a higher order of geospatial display and analysis can be undertaken remotely at the network servers 101. Automation servers 201 operate independently sending out their own alerts and managing their own local networks and this adds robustness to the system and improves immunity to network attack such as denial of service. Coordination is improved globally using distributed network servers 101 to coordinate groups of automation servers 201 and these might optionally send out their own alerts based upon the analysis of the data and metadata supplied by automation servers 201. The configuration data of each automation server 201 might be managed at the network servers 101 or, alternatively, might be centralised in a central configuration server 400 if provided. The network servers 101 might also undertake computationally intensive analysis of the data or, in an alternative embodiment, the data is transmitted to the processing server 600 as described in the third embodiment and illustrated schematically in FIG. 3.

It is further the case that access to such information will beneficially need to be on a secure basis such that proper authentication to access data from the automation server 201, network server 101, processing server 600 or central configuration server 400 is used.

The primary advantages of this method of operating are that:
1) People “on the ground” can refer to the hierarchical names for managing their automation space. People who access the information from afar can also converse using the hierarchical names but can aggregate and access data based upon absolute geographical data to the nearest that it is possible, feasible or desirable to be accurate. Thus it is easy to manage locally but coordinate globally.
2) Networks and machines can aggregate data based upon the date, time and location and operate on it in an easy way. Thus the information may be referenced and managed easily by both machine and human regardless of whether they are familiar with the local environment or not.

The process control system 500 described above has many applications. An example of the implementation and use of such a process control system 500 is in security and situational awareness, for example for military use.

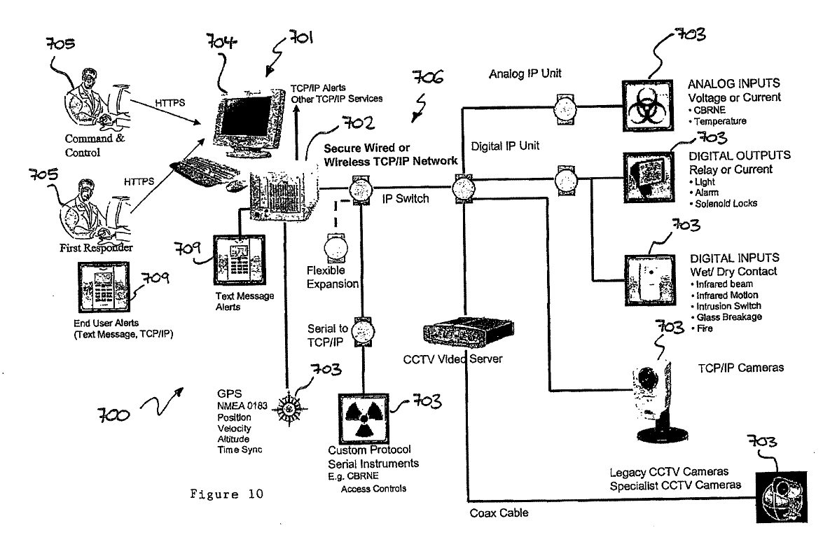

FIG. 10 illustrates schematically how the process control system 500 could be used for security and situational awareness in a military environment, that is an automation system 700.

Multiple users 705 of the automation system 700, such as Command and Control operators, Field Operatives and Expeditionary Forces, all act as network users with access to one or more network servers 701 using user terminals 704. In this embodiment, the network servers 701 are provided by computers loaded with appropriate software.

Peripheral devices 703 are located remotely and are used to collect data and information from their location. The peripheral devices 703 may include, but are not limited to, Closed Circuit TV cameras, IP cameras, Chemical Biological Radiological Nuclear Explosive (“CBRNE”) sensors, Velocity Position Altitude (“VPA”) sensors, and intrusion detectors. These peripheral devices 703 are coupled to a secure automation server 702 in the usual way and are operable to provide data to the automation server 702 and to receive control and configuration data from the automation server 702. The network servers 701, the local user terminals 704, and the automation servers 702 are all provided in a network 706 in data communication with each other. The data communication can be, for example, using IP protocol or any other suitable data communications protocol as is well known in the art.

In the automation system 700, peripheral devices 703 can be coupled to filter voluminous information to produce alerts via alerting devices 709 dynamically and allow easy change for continuous improvement and were originally developed for homeland security applications. All algorithms and efforts to distil the large body of physical information fall under “security automation” including motion detection, invariant frame rejection, sensor video integration, and behavioural and pattern matching (e.g. biometric, or target) recognition. In essence this automation system 700 automates the large task of monitoring many sites giving information to the right person in the chain of command for action.

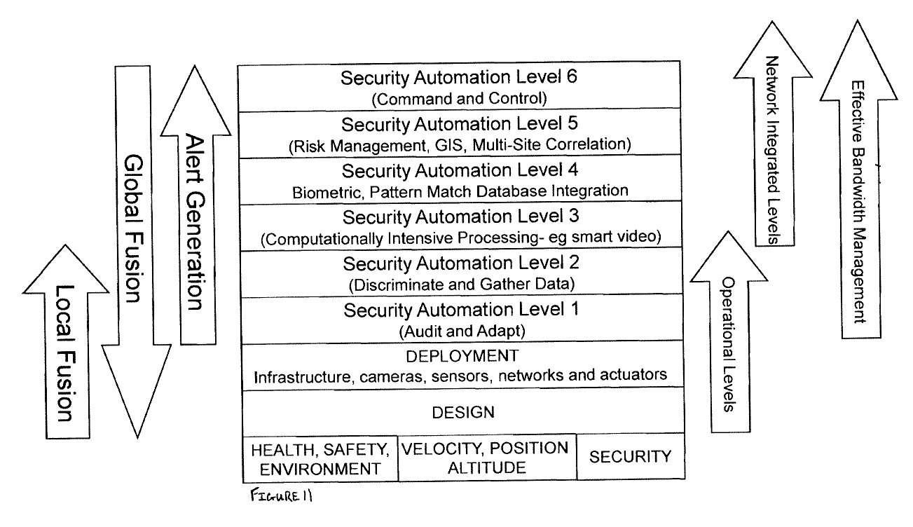

FIG. 11 schematically illustrates the levels of the automation system 700 of the invention.

The physical world is the lowest layer of the automation system 700. Data can be collected from security inputs (audio, video, access controls, motion and CBRNE sensors), a vehicle or vessel's instruments, Velocity, Position and Altitude (“VPA”) and also from health, safety and environmental (“HSE”) sensors. The Deployment layer allows for the flexible and economic deployment of the physical security implementation by using the plug and play nature of the peripheral devices 703 along with simple network engineering. Deployment can be achieved quickly by using a technician's skills without the overhead of a large integration program to bring together the stovepiped systems that present a problem in the prior art.

Use layer one further manages the peripheral devices 701. This allows for the security automation system 700 to be economically audited, adapted and upgraded to cope with changed threat levels, new device capabilities or other environmental changes. As an example, a new peripheral device can simply be added. Typically, a new sensor or device can be integrated in under five minutes compared with the hours of programming for a conventional, normally engineered system.

Layer two enables the integration of peripheral devices 703 such as sensors, actuators and cameras with automatic relationships, This is the layer relating to the discrimination and gathering of data from the peripheral devices 703. This layer provides the bulkhead against the vast amount of physical data that can be collected and is the foundation of bandwidth management. Typical automation actions include visual motion detection (often implemented in the camera itself), sensed motion detection (typically infrared sensors) and CBRN (or other sensor) based video triggering and event generation. Alerts can be generated at this layer directly and might be simple alerts for local expeditionary forces, a guard detail stationed at a permanent or temporary camp facility or remote forces including any level of the command chain as deemed operationally necessary on a dynamic basis. By using this layer of automation, dynamic flexibility to threat levels is achieved and the engineering problems of data storage and bandwidth planning are mitigated.

At layer two the automation system 700 provides a fully functioning decentralized situational awareness system.

User terminals 704 are deployed with expeditionary forces either hand-held, at a camp, or in a vehicle or vessel, on a ruggedized PC platform and then networked over wired or secure wireless TCP/IP giving rich local bandwidth around the server to handle video and many sensors and devices.

Layer three of the security automation model provides computationally intensive activities (such as video analysis or complex sensor analysis) that may be achieved in the network server 701 itself or might be delegated to other machines over the network 706. As they are computationally intensive it is often beneficial to execute this remotely using the bandwidth management delivered by layer two of automation.

Layer four typically deploys biometric or pattern matching and techniques such as facial recognition or target identification. The preceding levels of automation act to manage the bandwidth needed to effectively accomplish this remotely. This layer can optionally be implemented in the network server 701 but is likely to be delegated to a remote secure biometric and target/pattern matching database.

Layer five is the domain of intelligence distillation software and techniques and is the first layer unlikely to be implemented at all in a local server since it benefits from multi site data integration as described herein. Multi-site data comparisons provide the required information to find anomalies from the previous layers of security automation. Here intelligence analysts operate on the retrieved automation data with the advantage of being able to browse specific lower layer data from each network server 701 in its entirety if this is justified.

Layer six security automation is the command and control layer. Here specific threats, alerts and information are displayed and acted on, typically using geographical information systems. Regional or wide area alerts rather than local events are logged and acted upon. Like the intelligence analysts, all authorized personnel from the chain of command can operate on the retrieved automation data with the advantage of being able to browse each network server 701 in its entirety if detailed analysis is justified.

Layers three and above are typically network based and connectivity is delivered by open standard TCP/IP integration. Typical open integration standards include HTTPS, XML and database integration. Layers two and below are typically implemented within a single computing device and so use inter-process communications and standards that are more appropriate within a such a computing device, rather than the network protocols used for layers three and above.

The network servers 701 can scale to deliver this model of operation on a handheld computer or a supercomputer from megabytes to petabytes of storage using reliable commercial and off the shelf hardware of commercial, industrial or military grade. In conjunction with domain expertise, they can be cost effectively deployed in any country in the world by using hardware, software and expertise that is available globally. This means that cost is reduced and effectiveness is increased from locations as diverse as vehicles, vessels, aircraft, (temporary and permanent) bases and private residences.

By employing the networks of systems and as described herein, organised around the layers of the invention it can be readily appreciated that very complex systems that integrate physical information and devices can be adapted by people acting remotely and coordinating globally. This could be in a planned way such as is seen in a hierarchically organised military, an enterprise such as a global corporation or by people sharing their information sensors and devices in a less formally organised way.

It will be readily understood by persons skilled in the art, that modifications are possible within the scope of the present invention, and that the invention is not limited to the embodiments described. For example, alternative, known, querying and communication protocols can be used. Other network configurations might be ultilised. Additionally, features described in each embodiment may be combined to form yet further embodiments.

What is claimed:

1. A process control system comprising a network of sub-networks, each sub-network comprising an automation server having at least one peripheral device coupled thereto, and having data stored thereon, including location data for the automation server and additional data, the network further including at least one network server with a network user terminal coupled thereto, and each of the automation servers within the network is coupled to one of the at least one network servers for communication of data therebetween, the at least one network server being operable to receive data exported from a selected automation server transmitted in response to a query from one of the at least one network servers to the selected automation server, wherein the selected automation server is queried by the network server on the basis of the location data.

2. A process control system according to claim 1, wherein the one of the at least one network servers is operable to query a selected automation server on the basis of its near location to a selected geographical location.

3. A process control system according to claim 1, wherein the one of the at least one network servers is operable to transmit the query as a broadcast query to a set of selected automation servers.

4. A process control system according to claim 1, wherein the one of the at least one network servers is operable to transmit the query by sequentially polling a set of selected automation servers.

5. A process control system according to claim 1, wherein the data received by the one of the at least one network servers is stored locally at the one of the at least one network server for subsequent access.

6. A process control system according to claim 1, wherein the one of the at least one network servers is operable to emit an alert where the data received from the selected automation server matches predefined criteria.

7. A process control system according to claim 1, further including a configuration server provided in the network and coupled to the sub-networks and the at least one network server, the configuration server being operable to store data exported from automation servers of the sub-networks thereon, such that one of the at least one network servers is operable to retrieve data from the configuration server.

8. A process control system according to claim 1, further including a processing server provided in the network and coupled to the sub-networks and the at least one network server, the processing server being operable to query selected automation servers of the sub-networks for further processed data.

9. A process control system according to claim 1, where the network server is operable as both the network server and an automation server.

10. A method of process control using a process control system comprising a network of sub-networks, each sub-network comprising an automation server having at least one peripheral device coupled thereto, and having data stored thereon, including location data for the automation server and additional data, the network further including at least one network server with a network user terminal coupled thereto, wherein each of the automation servers within the network is coupled to one of the at least one network servers to facilitate communication of data therebetween, the method including the steps of:
querying one or more of the automation servers on the basis of the location data by transmission of a query from one of the at least one network servers; and
receiving data exported from an automation server transmitted in response to the query from one of the at least one network servers to the automation server.

11. A method according to claim 10, where in the query is on the basis of the near location of an automation server to a selected geographical location.

12. A method according to claim 10, wherein the query is broadcast to a set of selected automation servers.

13. A method according to claim 10, wherein the query is a sequential polling of a set of selected automation servers.

14. A method according to claim 10, including the step of storing the data received by the one of the at least one network servers locally at the one of the at least one network servers for subsequent access.

15. A method according to claim 10, including the steps of:
storing the data exported from automation servers of the sub-networks on a configuration server provided on the network; and
retrieving data from the configuration server.

16. A method according to claim 10, including the step of querying selected automation servers of the sub-networks for further processed data.

17. A network server for a process control system, the network server being provided in a network of sub-networks, each sub-network comprising an automation server having at least one peripheral device coupled thereto, and having data stored thereon, including location data for the automation server and additional data, the network further including at least one network server with a network user terminal coupled thereto, wherein each of the automation servers within the network is coupled to one of the at least one network servers to facilitate communication of data therebetween, the at least one network server being operable to receive data exported from a selected automation server transmitted in response to a query from one of the at least one network servers to the selected automation server, and the selected automation server is queried by the network server on the basis of the location data.

18. A network server according to claim 17, wherein the one of the at least one network servers is operable to query a selected automation server on the basis of its near location to a selected geographical location.

19. A network server according to claim 17, wherein the one of the at least one network servers is operable to transmit the query as a broadcast query to a set of selected automation servers.

20. A network server according to claim 17, wherein the one of the at least one network servers is operable to transmit the query by sequentially polling a set of selected automation servers.

21. A network server according to claim 17, wherein the one of the at least one network servers is operable to emit an alert where the data received from the selected automation server matches predefined criteria.

22. A configuration server for a process control system, the configuration server being provided in a network of sub-networks, each sub-network comprising an automation server having at least one peripheral device coupled thereto, and having data stored thereon, including location data for the automation server and additional data, the network further including at least one network server with a network user terminal coupled thereto, wherein each of the automation servers within the network is coupled to one of the at least one network servers to facilitate communication of data therebetween, and the configuration server is coupled to the sub-networks and the at least one network server, the configuration server being operable to store data exported from automation servers of the sub-networks thereon, such that one of the at least one network servers is operable to retrieve data from the configuration server.

23. A processing server for a process control system, the processing server being provided in a network of sub-networks, each sub-network comprising an automation server having at least one peripheral device coupled thereto, and having data stored thereon, including location data for the automation server and additional data, the network further including at least one network server with a network user terminal coupled thereto, wherein each of the automation servers within the network is coupled to one of the at least one network servers to facilitate communication of data therebetween, and the processing server is operable to query selected automation servers of the sub-networks for further processed data.
